(19) United States
(12) Patent Application Publication
(10) Pub. No.: US 2026/0157553 A1
(43) Pub. Date: Jun. 11, 2026

(54) SECURITY BOX

(71) Applicant: Matthew Prestwich Construction, Inc., Murray, UT (US)

(72) Inventors: Matthew Prestwich, Salt Lake City, UT (US); Jacob Prestwich, Murray, UT (US)

(73) Assignee: Matthew Prestwich Construction, Inc., Murray, UT (US)

(21) Appl. No.: 19/183,406

(22) Filed: Apr. 18, 2025

Related U.S. Application Data
(60) Provisional application No. 63/636,858, filed on Apr. 21, 2024.

(51) Int. Cl. A47G 29/20

(52) U.S. Cl. CPC A47G 29/20

(57) ABSTRACT

A security box utilizes a cam lock and latch system to secure an access door against unauthorized intrusion. The system further comprises a hooked cam latch and a set-off latch stop placed at some distance from the access door. This set-off latch stop may be a wall-piece cantilevered on a portion of the lock or another support, or it may be in the form of a bracket secured to the welded to the inside frame. The set-off latch stop prevents the cam latch from becoming separated from the cam lock during a pry attack. If the attack continues, the cam latch will deform and cause the cutout hook at the end of the cam latch to engage the set-off latch stop and bind the door to prevent it from opening. An additional internal bracket may divert force from the access door hinge during an attack

### CROSS-REFERENCES TO RELATED APPLICATIONS

The present invention claims the benefit of prior filed U.S. Application No. 63/636,858, titled “MAILBOX WITH IMPROVEMENTS TO COMBAT PRYING ATTACKS MORE EFFECTIVELY” and filed on Apr. 21, 2024, and incorporates the same by reference herein in its entirety.

### FIELD OF THE INVENTION

The present invention relates to the field of security locking boxes and more particularly relates to a security drop box, which may be a mailbox, having a lock structure that binds with itself during pry attacks.

### BACKGROUND OF THE INVENTION

Security boxes can be used for many different purposes, and may include security drop boxes, inter alia, payment deposit boxes, mailboxes, package delivery boxes and the like. These security drop boxes typically comprise two chambers: a delivery chamber and a receiving chamber. The delivery chamber may be freely accessed by a door with a security tray mounted thereon. The security tray is configured to make it difficult for somebody to reach through the door to access and retrieve items in the receiving chamber. Alternatively, the delivery chamber can be a narrow slot configured to be narrow enough that somebody could not reach through the slot to access and retrieve items in the receiving chamber, but this tends to limit the size of what may be deposited. Individuals wishing to deposit items into the box typically deposit items into the delivery chamber where it then drops securely down to the receiving chamber. The receiving chamber is typically accessed by a door protected by a lock and latch system to prevent anybody from retrieving items deposited in the security box except those individuals with the key or combination to the lock.

The chambers of most security drop boxes 10 (FIG. 1) are typically oriented vertically with the delivery chamber 12 located on the top portion of the security box and the receiving chamber 16 located on the bottom portion of the security box, but other orientations may be possible. Additionally, the security drop box could be configured with one large chamber with a locked access door and a narrow slot or small delivery door cut into the access door. For the purposes of this document, the delivery chamber may interchangeably be called by the terms “top chamber” and “delivery chamber,” and the receiving chamber may interchangeably be called by the terms “bottom chamber,” “receiving chamber,” “access chamber,” and “retrieval chamber” without limiting the invention to any particular orientation or configuration. A security box with a unified single chamber may have a “delivery chamber” and “receiving chamber” artificially designated without corresponding delineation structure. Additionally, for the purposes of this document the door accessing the delivery chamber 14 (if any) may interchangeably be called by the terms “top door” and “delivery door, and the door accessing the receiving chamber 18 may interchangeably be called by the terms “bottom door,” “receiving door,” “access door,” and “retrieval door” without limiting the invention to any particular orientation or configuration. Similarly, any directional or orientational terms are meant to describe the preferred embodiment without limiting the scope of the invention.

The access door of many locking security drop box designs are commonly protected by a staple cam lock and latch system such as is shown in FIG. 2. Cam locks typically comprise a locking means on the outside (front) of the lock 20 (which locking means can be, inter alia, a key and tumbler system, a combination based or keypad based system, or other locking system) and a connecting rod 22 connecting the locking means to a cam latch 24 on the inside of the lock. The connecting rod 22 is typically threaded so that the cam latch can be held to the lock by fastening it to the connecting rod using a nut 26 or other connecting means. However, other fastening means could be used to fasten the cam latch to the connecting rod. The user rotates the locking means of the cam lock 10, which in turn rotates the connecting rod 22, which in turn rotates the cam latch 24 from the unlocked to the locked position, behind a portion of the frame, a bracket or some other internal blocking structure 28. This portion of the frame where the cam latch 24 interfaces what commonly known as the “closing line” or the “abutment line.” Hereinafter this document will refer to it as the Closing Line.

Most cam locks are made from brass, however, sometimes manufacturers will make cam locks from other materials such as stainless steel. Cam latches can be made from a variety of materials including brass, steel, stainless steel as well as other materials. Cam latches can be made using a variety of material hardness and ductility. Some cam latches can be made using steel that has low ductility (i.e., brittle steel), while other cam latches can be made from steel with high ductility.

Criminals or other unauthorized individuals often attempt to force open the locked access door on a security drop box by using a pry bar or other prying means to pry the access door away from the frame (hereinafter referred to as a “pry attack”). The purpose of the pry attack is to use force to cause the cam lock and latch system to fail and allow the access door to come open so the contents of the security box become accessible to the unauthorized individual. During a pry attack the force of prying causes a corresponding resisting force from the frame of the mailbox onto the cam latch which can then translate directly to the cam lock. This force on the cam latch can cause the cam lock and latch system to fail in a variety of different ways.

The most common failure is caused because the cam latch 24 is made from thin, ductile metal and it simply bends or folds over at the Closing Line in response to the prying forces, which allows the access door to open. Some practitioners have responded to this failure mode by increasing the thickness or hardness (or both) of the cam latch 24. While this solves the problem of the latch bending or folding over, it instead transfers a bending force directly to the connecting rod 22 going through the center of the lock. This bending force can cause the connecting rod 22 to fail by breaking in half which will cause the cam latch to disconnect from the lock allowing the access door to open. If the connecting rod, in turn, is strengthened by using a tougher material or by making it thicker (or both), then it simply transfers the failure mode due to the forces of the pry attack to the connecting means, such as nut 26, that connects the cam latch 24 to the connecting rod 22 of the cam lock. Since typically this connecting means comprises threads on the connecting rod 22 of the lock, and a nut 26 holding the cam latch to the threaded connecting rod, the force from the pry attack will cause the nut 26 to strip the threads on the connecting rod, which causes nut 26 and the cam latch 24 to become detached from the lock, allowing the access door to open.

Another failure mode can be caused by the cam latch 24 itself being made of brittle material instead of ductile material. For example, in the ductile steel scenario outlined above, the force from the pry attack causes the cam latch to simply bend or fold over. However, if the cam latch is made from a brittle material, then instead of bending the cam latch may actually break into two pieces, allowing the access door to open

Finally, secure drop boxes typically have one side of the access door attached to the frame of the drop box by a hinge depicted in FIGS. 1, 19. The forces that occur during a typical pry attack exert a force on the hinge 19, which can cause the hinge itself to fail, or the connection from the hinge to the access door to fail, or the connection from the hinge to the frame of the drop box itself to fail.

The above modes of failure of cam latch and lock systems will hereinafter be referred to as “traditional cam lock failure modes” collectively or a “traditional cam lock failure mode” individually.

Various practitioners have tried to solve the traditional cam lock failure modes outlined above. For example, U.S. Pat. No. 4,823,571 to O'Gara (hereinafter referred to as “O'Gara” and incorporated herein by reference) attempts to solve the problem by fixedly mounting a retaining bracket to the inside face of the access door in an attempt to retain the latch during a pry attack. The bracket is in the shape of a “U” with the center of the U shaped retaining bracket containing a hole coincident with a hole in the access door in which the cam lock is mounted. Each side of the U shape contains a cutout, with the cutout in each of the sides both facing the same direction.

The retaining bracket in O'Gara is an improvement over the traditional staple cam lock and latch system discussed above. However, O'Gara's approach has at least two weaknesses. The first weakness is that if the latch is ductile, the prying forces can still cause it to fold or bend over directly above the level of the bracket (where the latch contacts the frame of the delivery box) during a pry attack. Alternatively, if the latch is brittle, it can cause the latch to break at this point. The second weakness is that pressure from the latch on the distal edge of the bracket can cause this distal edge of the bracket to deform. Once this edge deforms it no longer acts to retain the bracket and all of the prying forces outlined above are now acting directly on the lock which can then cause one or more of the traditional cam lock failure modes outlined above. What is most likely is some combination of the cam latch bending or breaking, and the retaining bracket simultaneously deforming and thus causing one or more traditional cam lock failure modes.

It should be noted that both cutouts in the sides of the U shaped bracket in O'Gara point in the same direction. This allows a traditional cam latch to rotate from the fully up position to the fully down position. However, it does not allow for an elongated cam latch that extends fully in both directions to be installed since the elongated cam latch will not be able to rotate when turning the lock without striking the U shaped bracket. Thus, the bracket in O'Gara only provides a partial latch retention function.

In U.S. Pat. No. 7,441,696 to Bolles (hereinafter referred to as “Bolles” and incorporated herein by reference) the practitioner attempts to solve the problems outlined above by fixedly attaching a bracket to the inside face of the access door (what Bolles refers to as an “anti-pry plate”) that serves a similar function to the bracket in O'Gara, and additionally by installing a striker pin through the center frame of the security box with said striker pin extending into the interior of the security box, and using an elongated cam latch with a cutout on one side of the latch that is “rotatably engaged” (in the words of Bolles) to the striker pin when the user turns the key in the lock. In other words, the cutout in the cam latch is oriented such that it engages the striker pin in a transverse, or “sideways” direction.

Bolles' invention offers a significant improvement over O'Gara, but also suffers from two weaknesses. When a pry attack occurs with a pry bar prying the edge of the access door, there are typically two components of force. One component of force is directed toward the hinge and another component of force is directed outward. During the initial phase of a pry attack much of the force will be directed toward the hinge (downward in this case). However, as the pry attack proceeds and the door is pried open, the outward component of force will continue to increase. The first weakness of Bolles is that the downward force of a pry attack exerts a corresponding downward force on the cam latch which in turn exerts a downward force on the striker pin. This downward force can cause the striker pin to either deform or break. Alternatively, since the striker pin extends through the center frame of the security box, it can cause the center frame of the drop box itself to twist and deform. Both scenarios may also happen, where the striker pin and center frame will break and/or deform. In these cases, the striker pin will deform downwardly and the cam latch will slip off the distal end of the striker pin and the access door to the drop box can be opened. The second weakness of Bolles is that because the cutout of the cam latch engages the striker pin from the side (in other words in a sideways manner), during a pry attack there is nothing keeping the cam latch from slipping back off the same side except for the rotational mechanical resistance contained inside the lock itself. If the lock fails, then it becomes easier for the cam latch to slide back off the same side of the striker pin in which it initially engaged. Also, the cam latch engages the stationary receiver (striker pin) during normal operation of the lock. Another problem with this configuration is that if the cutout on the side of the cam latch becomes mis-aligned with the striker pin it could cause the cam latch to not engage the stationary receiver thus negating the security feature.

Also, in Bolles' disclosure it is possible that the portion of the cam latch above the cutout might deform during a pry attack due to its long and thin cantilevered nature and rotatable engagement with the striker pin. This deformation would be detrimental because it would make it easier for the cam latch to slide off the striker pin during a pry attack.

The present invention is a security drop box that utilizes a latch retention bracket, located internal of the access door, cooperating with a hook engagement bracket, located internally of the frame, to secure an elongated hooked cam latch. The system also binds the cam latch to the hook engagement bracket during a pry attack, further securing the lock, door, and contents. Further, an added brace may be used to limit downward force on the hinge of the access door, bolstering the overall security of the drop box. The present invention represents a departure from the prior art in that the locking structure of the present invention allows for increased resistance to pry attacks without diverting force to other, weaker, points of the security box's construction.

### SUMMARY OF THE INVENTION

In view of the foregoing disadvantages of the known types of cam lock and latch systems, the present invention provides an improved cam lock and latch system. As such the present invention's general purpose is to provide a new and improved cam lock and latch system that can be used in any application appropriate for cam lock and latch systems, including security drop boxes.

To accomplish these objectives, the cam lock and latch system comprises a Hook Engagement Bracket that is fixedly attached to the frame of the security box in a position adjacent to the side of the access door containing the cam lock and latch, a cam lock, an elongated cam latch with a cutout hook positioned at one end of the cam latch oriented such that when the cam latch is in the locked position, the gape of the cutout hook is positioned adjacent to the Hook Engagement Bracket, but not engaging the Hook Engagement Bracket. If the cam lock and latch has a vertical orientation when the access door is locked, the gape of the cutout hook on the cam latch could be said to be positioned above the Hook Engagement Bracket.

The latch construction further comprises a Latch Retention Bracket that is fixedly attached to the inside face of an access door of a security drop box, with said Latch Retention Bracket formed in the shape of a U. The center of the U-shaped Latch Retention Bracket contains a hole coincident with a hole in the access door through which the cam lock is mounted, and each side of the U-shape contains a cutout, with the cutout in each side facing away from each other such that when the cam lock is mounted to the access door, and an elongated cam latch is fastened to the cam lock, the elongated cam latch can freely rotate 90 degrees from the unlocked to the locked position, with the cam latch in the locked position occupying the space left by the cutouts in each side of the U-shaped Latch Retention Bracket.

During normal operation of the cam lock and latch the cutout hook on the cam latch does not engage with the Hook Engagement Bracket when the door is locked, but during a pry attack against the locked access door of the security box, the cam latch can deform, with said deformation causing the gape of the cutout hook in the cam latch to move toward the Hook Engagement Bracket and causing the cutout hook to engage with the Hook Engagement Bracket. Even if the cam lock itself completely fails, the cam latch will not slip off the Hook Engagement Bracket because it will stay “cinched” or bound in place by the deformation of the cam latch between the Latch Retention Bracket mounted to the door, and the Hook Engagement bracket mounted to the frame of the security box.

The system further comprises a brace fixedly attached to the hinge side of the access door such that the brace is positioned adjacent to the frame of the security box when the access door is closed. Prying forces on the lock side of the access door can allow this brace to contact the frame of the mailbox and direct the prying forces directly from the brace to the frame of the mailbox thus allowing the forces to bypass the hinge or attachments from the hinge to the access door or the frame of the mailbox. By resisting prying forces with the brace contacting the frame rather than by the hinge itself, or the fastening means used to attach the hinge to the security box and the door, the resisting force is much stronger.

The more important features of the invention have thus been outlined in order that the more detailed description that follows may be better understood and in order that the present contribution to the art may be better appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view of a security drop box, according to one embodiment of the present invention

FIG. 2 is a prior art cam lock as is commonly used in security boxes.

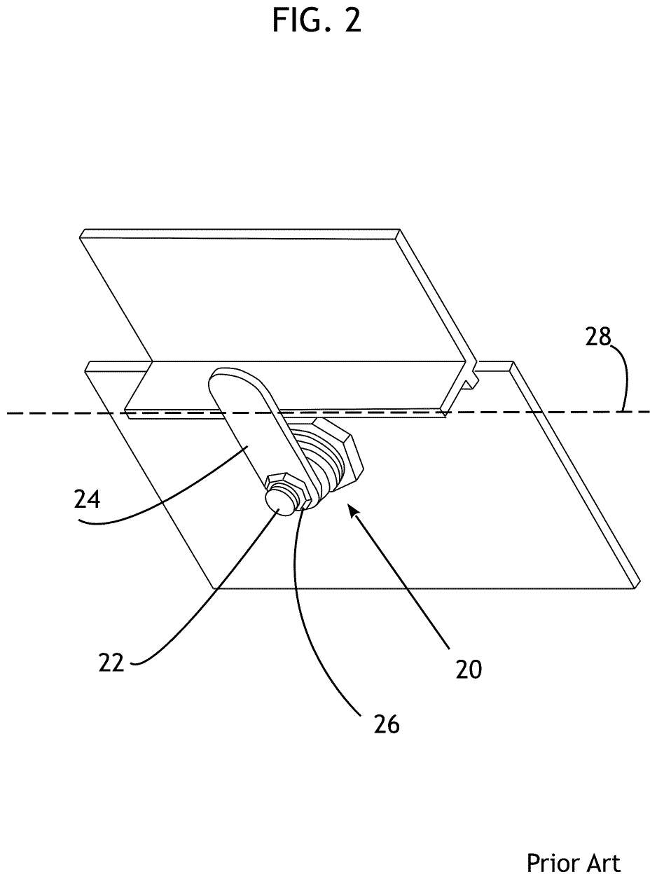

FIG. 3 is a perspective view of the inside of the access door of the security drop box of FIG. 1.

FIG. 4 is a perspective view of the access door of FIG. 3, with the lock in an open configuration.

FIG. 5 is an alternate perspective view of the access door of FIG. 3, with the lock structure removed.

FIG. 6 is a perspective view of the inside of the security lock box of FIG. 1, locked, focusing on the lock area.

FIG. 7 is an enlarged view of the security lock box of FIG. 6, taken in circle VII.

FIG. 8 is a perspective view of the inside of the security lock box of FIG. 1, locked and focusing on lock and the access door hinge.

FIG. 9 is a perspective view of the security lock box of FIG. 1, during a pry attack.

FIG. 10 is a perspective view of an alternate embodiment of the present invention.

### DESCRIPTION

With reference now to the drawings, a preferred embodiment of the security drop box is herein described. It should be noted that the articles “a,” “an,” and “the,” as used in this specification, include plural referents unless the content clearly dictates otherwise.

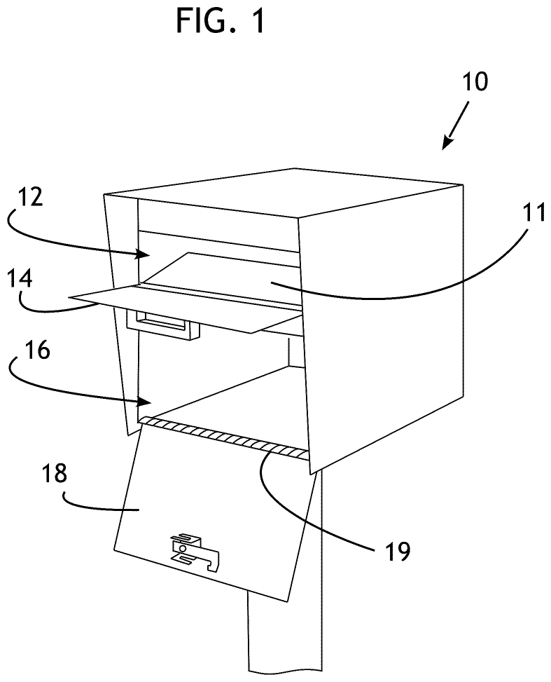

While it is possible for locking security drop boxes to have different configurations, the preferred embodiment in this disclosure is applied to a configuration of locking security drop box that can be seen in FIG. 1, which depicts a locking security drop box comprising a delivery chamber 12 and a receiving chamber 16, oriented vertically with the delivery chamber 12 located on the top portion of the security box and the receiving chamber 16 located on the bottom portion of the security box. Note that as illustrated, the delivery chamber and the receiving chamber share the same common volume. These structures are commonly utilized for mail boxes, however it should be noted that uses for purposes other than mail and parcel delivery are possible and the Specification and Claims should not be read as limiting to simply “mailboxes.”

The delivery chamber 12 can be freely accessed by a door 14 with a security tray 11 mounted to the door (the purpose of the security tray 11 being to make it difficult for somebody to reach through the opening to access and retrieve items in the receiving chamber). The receiving chamber 16 is accessed by a door 18 which has the cam lock and cam latch mounted to it as well as the Latch Retention Bracket 40 of the present invention.

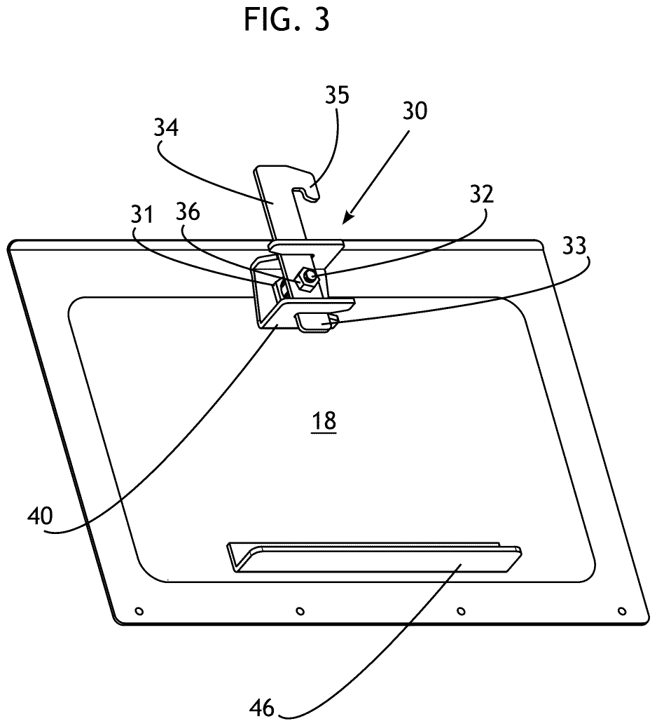

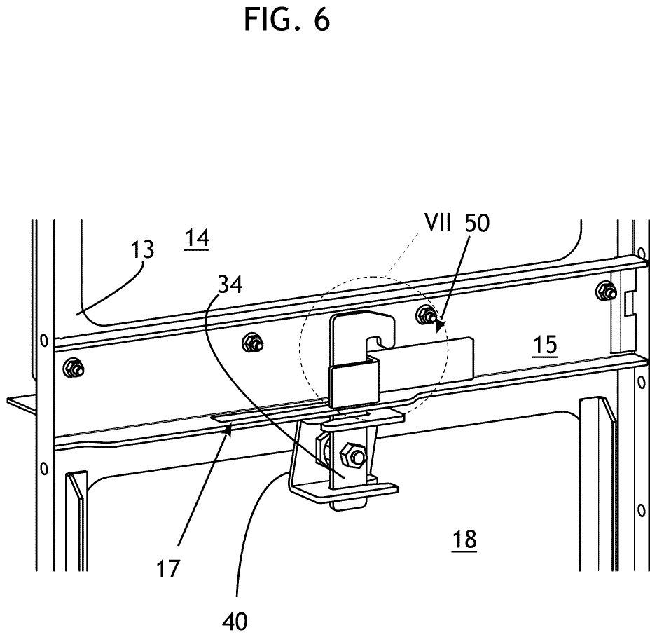

The preferred embodiment of the invention as depicted in FIGS. 3 and 6 comprises a cam lock 30 attached via a threaded nut 31 to the access door 18 of the security box, and an elongated cam latch 34 attached to the cam lock via a second threaded nut 36 and a connecting rod 32 extending therethrough. The elongated cam latch 34 has a cutout hook 35 positioned in one end of the cam latch with the gape of the cutout hook oriented facing toward the toward the cam lock (in the preferred embodiment this direction is facing downwards), and the other end of the cam latch 33 elongated in the opposite direction.

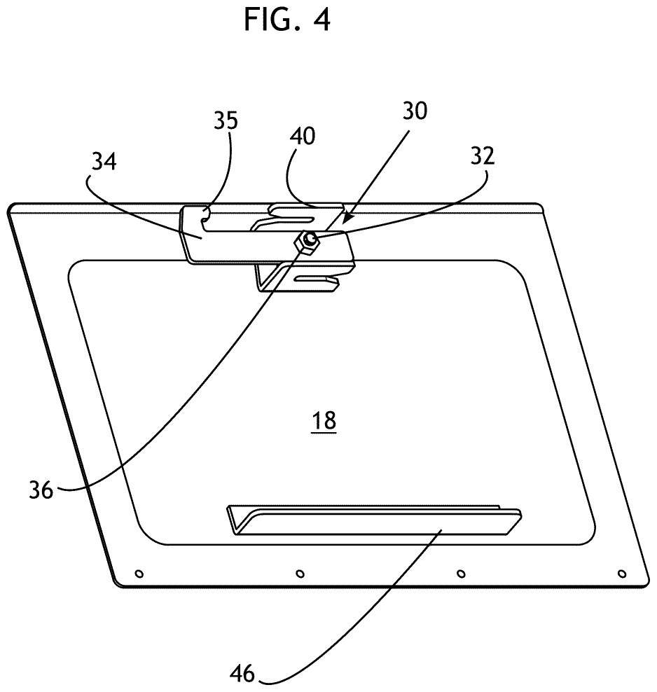

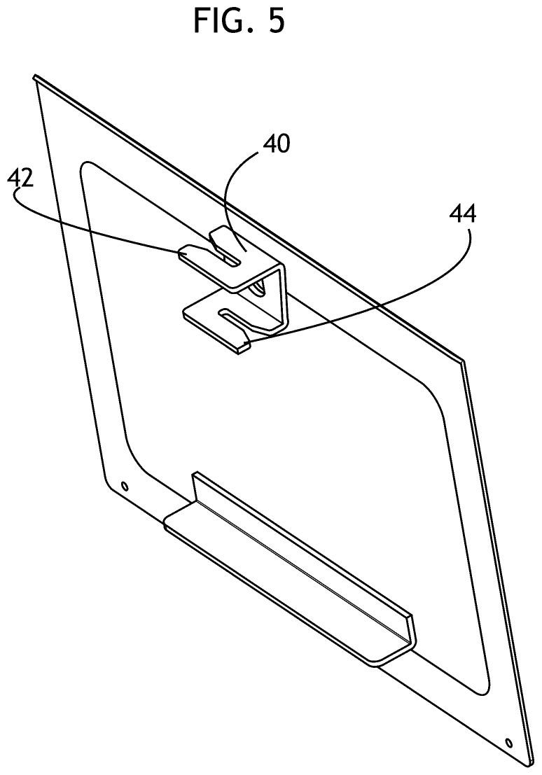

The preferred embodiment further comprises a Latch Retention Bracket 40 welded to the inside face of the access door 18 of the security box. The Latch Retention Bracket is generally formed in the shape of a “U”, with the center of the U-shape containing a hole positioned coincident with a hole in the access door in which the cam lock is mounted such that the cam lock mounts to both the access door and the Latch Retention Bracket. As depicted in FIGS. 4 & 5, each side of the latch retention bracket contains oppositely facing cutouts 42 and 44 such that when the cam lock 30 and cam latch 34 are mounted in the access door 18, the elongated latch is able to rotate juxtapositioned within the cutouts (FIG. 5). The opposite facing directions of the cutouts 42, 44 of the Latch Retention Bracket 40, as opposed to similarly facing cutouts as seen in the prior art, allow the elongated cam latch 34 to rotate freely 90 degrees from the unlocked position depicted in FIG. 4 to the locked position depicted in FIG. 3.

As depicted in FIG. 6, the preferred embodiment further comprises a Hook Engagement Bracket 50 welded to the crossmember 15 of frame 13 of the security box above the closing line 28, with the Hook Engagement Bracket generally formed in the shape of a “Z” with one leg 52 welded to the frame of the security box and the other leg 56 extending off of the cantilevered stem of the Z 54, thereby forming a pocket 58 occupied by the cam latch 34 when the cam lock is rotated into the locked position. While the preferred embodiment is constructed using a Hook Engagement Bracket formed in the shape of a Z, other shapes for the Hook Engagement Bracket are possible while maintaining the overall function and intent of the present invention. Specifically, a set-off plate or structure 56 that is essentially parallel to the frame 13, forms the requisite pocket 58 in which the cam latch 34 may reside. This requires the perpendicular structure, whether truly cantilevered or not, and the transverse, parallel structure. This pocket should be just large enough for the cam latch 34 to pass through as a smaller pocket will not leave much room for the cam latch 34 to deviate from interfacing with the latch retention bracket 50 during a pry attack.

FIG. 6 further depicts a crossmember 15 of the frame 13 of the security box with a slot 17 cut into the crossmember which allows the cam latch 34 to rotate freely from the unlocked to the locked position. While crossmember 15 can act as a support platform for the Hook Engagement Bracket 50, it is possible to construct the present invention without crossmember 15 as long as the Latch Engagement Bracket 40 has sufficient strength and also has a sufficiently strong connection to the frame of the security box.

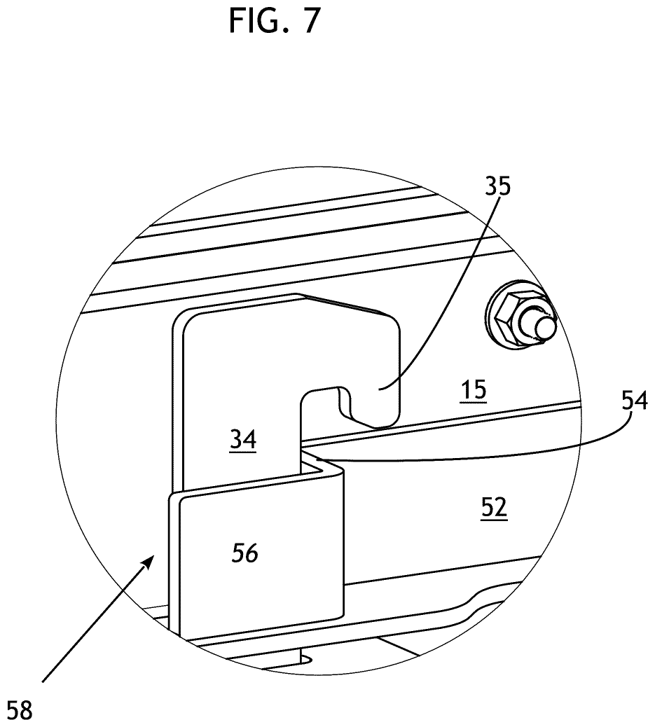

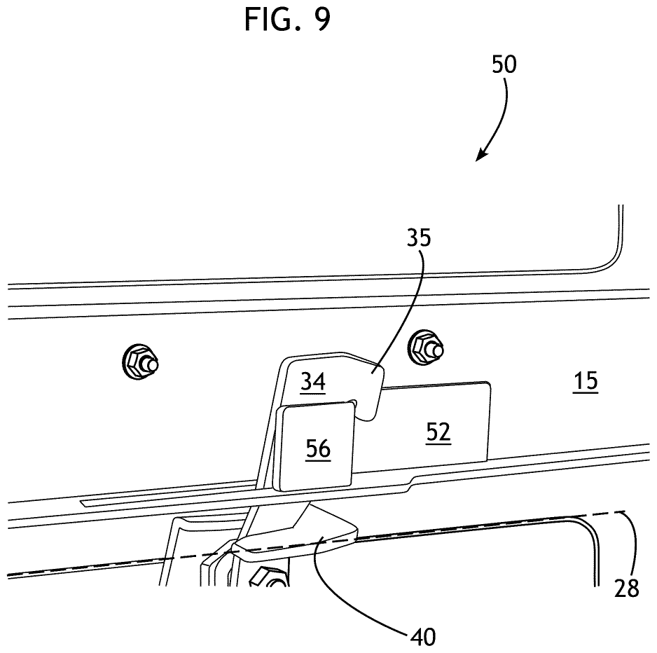

During normal locking and unlocking operation of the cam lock and latch system, the neither the cutout hook 35 nor the main body of the cam latch engage the Hook Engagement Bracket when in a locked configuration, but instead the gape of the hook is positioned above the Hook Engagement Bracket 50 (FIGS. 7 & 8). During a pry attack against the locked access door of the security box, the cam latch 34 can deform, with said deformation causing the gape of the cutout hook 35 of the cam latch to move toward the Hook Engagement Bracket 50, causing the cutout hook to engage with the Hook Engagement Bracket as depicted FIG. 9. FIG. 9 also depicts the deformation of the cam latch 34 during a pry attack on the locked access door of the security box and causes cam latch 34 to engage the Latch Retention Bracket 40. The combination of the Latch Retention Bracket 40 engaging the cam latch 34, and the cutout hook 35 of the cam latch engaging the Hook Engagement Bracket 50 provides a complete system that “cinches” or binds the access door of the security box closed during a pry attack on the access door 18, making it difficult if not impossible to pry the access door 18 open. Even if there is major deformation of the security box itself, or deformation of the access door 18, the present invention makes it much more likely for the “cinched” or bound cam latch 34 to remain engaged to the Hook Engagement Bracket 50 and hold the access door closed. Furthermore, even if the lock itself breaks during the pry attack, the cam latch 34 will remain “cinched” or bound in place through physical contact keeping the access door 18 closed.

Above the Closing Line 28 (between the top edge of the access door and the frame of the mailbox) the cam latch deforms in a transverse fashion (transverse to the frame 13 of the security box) causing a transverse opposing force to prying the door open.

While the Latch Retention Bracket 40 and the Hook Engagement Bracket 50 are designed to work together to bind the door closed during a pry attack, the Hook Engagement Bracket 50 could work even if there is a simplified retention bracket or even no retention bracket at all.

Also, in the preferred embodiment the cutout hook 35 of the cam latch is designed to engage the Hook Engagement Bracket 50. However, it is possible that through unexpected prying forces (for example, forces that cause the lock and latch to partially rotate) the cutout hook 35 fails to engage the Hook Engagement Bracket 50. In this case it is still possible for the cutout hook 35 to engage other parts of the security box which will have substantially the same effect as engaging the Hook Engagement Bracket and are therefore covered in the scope and spirit of the present disclosure. For example, the cutout hook 35 could engage the on the edge of crossmember 15 of the frame of the security box, or it could engage in or around the slot 17 cut into the crossmember 15.

As previously noted, the cutout hook 35 is positioned above the hook retention bracket 50 when the box is locked and does not engage the bracket at all unless subject to a pry attack of sufficient force to deform the cam latch 34. Having the cutout hook 35 positioned above the Hook Engagement Bracket 50 provides two distinct advantages over the prior art. The first and most important advantage is that having the cutout hook 35 above the Hook Engagement Bracket 50 allows for a complete hooked shape to be formed in the cam latch, not just a simple cutout. A simple cutout is more likely to slip off the stationary receiver (in Bolles' case, the striker pin) during a pry attack. Conversely, a completely formed hooked shape binds much more strongly to the stationary receiver (the Hook Engagement Bracket 50 in the case of the present invention) making it much more difficult to become dislodged. It is not possible for a completely formed hooked shape to fully engage a stationary receiver during normal rotational motion of cam lock actuation. To fully engage a cutout hook, a secondary direction of motion of the cutout hook toward the Hook Engagement Bracket 50 (stationary receiver) must be introduced. In the depicted embodiment the cutout hook 35 can be said to be “pulled” along the secondary direction of motion toward the Hook Engagement Bracket 50 by the force of the pry attack deforming the cam latch 34 and thus allowing the full binding action of a complete hook shape to be realized.

The second advantage of having the cutout hook of the present invention positioned above the Hook Engagement Bracket is that it eliminates the possibility of the cutout hook becoming misaligned with the Hook Engagement Bracket, thus keeping the security feature active at all times during normal lock operation.

The shape of the cutout hook 35 of the cam latch of the present disclosure is constructed in such a way that it is less likely to deform during a pry attack. Additionally, the deformation of the cam latch 34 of the present disclosure in the area between the top of the access door 18 and the frame 13 of the mailbox is what allows for the secondary direction of motion of the cutout hook 35 downward which the allows the cutout hook to engage the Hook Engagement Bracket. Therefore, in this case the deformation of the latch is actually a benefit to the security of the security box rather than detrimental.

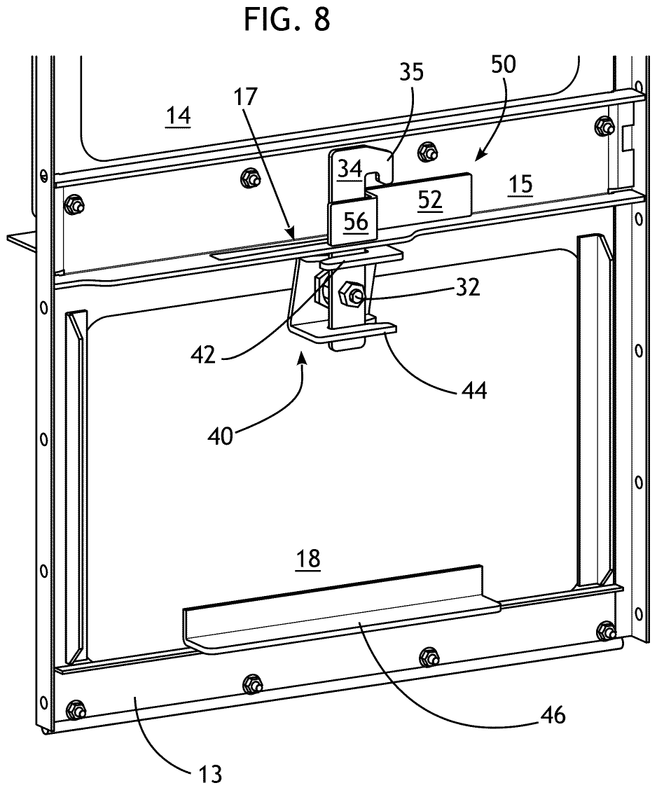

As depicted in FIG. 8, the preferred embodiment of the present invention further comprises a brace 46 welded to the hinge side of the access door adjacent to the access door hinge (opposite of bottom edge of access door 18). Prying forces on the lock side of the access door 18 can allow this brace 46 to contact the frame 13 of the mailbox and redirect the prying forces from the brace 46 to the frame 13 of the mailbox. This allows the forces to bypass the hinge or its attachment structure to the access door 18 or the frame 13 of the mailbox. By resisting prying forces with the brace 46 contacting the frame 13 rather than by the hinge itself or the fastening means holding the hinge, a skilled artisan will appreciate that more resisting force is achieved since the resisting force of a solidly welded brace contacting the frame is generally greater than the resisting force inherent in a hinge, or the fasteners which fasten the hinge to the door and the frame of the security box.

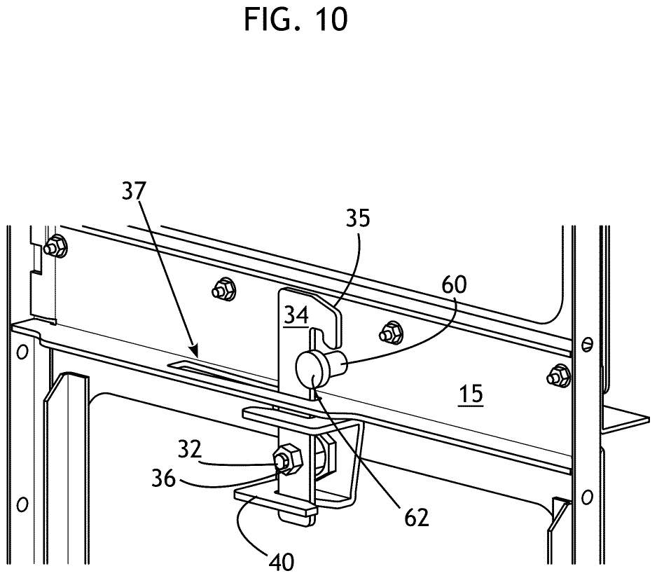

While the preferred embodiment uses a Z-shaped Hook Engagement Bracket attached to the frame of the security box, a skilled artisan appreciates that other configurations of cutout hook catching or cutout holding means could be used in various other ways, shapes, manners, or forms without departing from the scope of the present disclosure. On example is illustrated in FIG. 10, where the Hook Engagement Bracket is replaced by a pin 60 with a broad head 62. As with the previous embodiment, the gape of the cutout hook 35 faces downward over the cantilevered pin 60 and the cutout hook 35 and cam latch 34 do not normally interface with the pin 60. However, during a pry attack, the same forces will cause the cutout hook 35 to bind with the pin 60 and head of the pin 62 in the same manner as with the Hook Engagement Bracket 50 due to the cantilevered and removed interface structure of the pin 60. It should be noted that any structure that allows the cam latch 34 to bind to it during deformation will be sufficient for the invention to work, including but not limited to a cantilevered pin and head 60, 62, the Hook Engagement Bracket 50, walls extending from the crossmember 15, other wall structure integral to the crossmember 15, frame, 13 or walls, or any other structure which provides the perpendicular piece that is transversely offset from the wall. This would also include the structure of the crossmember 15 about the passage slot 17, absent any other structure. All of these types of structures, whereby the hook 35 of the cam latch 34 will interface therewith when the system undergoes deformation, such as through a pry attack, would be considered a “Hook Engagement Bracket,” regardless of attachment methodology. “Deformation” as used in this Specification and claims may broadly include deformation of the cam latch, the door, the lock, or the frame unless context clearly dictates otherwise.

While the preferred embodiment of the present invention is applied to a security box with a vertical orientation, this orientation does not limit the invention. Other orientations are possible. Also, the preferred embodiment is applied to an access door with the cam lock and latch on the top side of the access door and the hinge on the bottom side of the access door, which leads to a vertical orientation of the cam lock and latch system. However, other configurations are possible without limiting the invention. At least one alternate configuration could be applied to an access door with a horizontal configuration with the hinge on one side and the cam lock and latch system applied horizontally to the opposite side, with the cam lock and latch system having a horizontal orientation. In a horizontal orientation, the directions described in the preferred embodiment of “top,” bottom, “downward,” “upward,” “sideways” and any other directional or orientational terms should be adjusted accordingly. Furthermore, this invention may be practiced on security boxes that have only one door for both delivery and access. Such a security box would include lockers, which are commonly used to stow purchased items for individual pick-up and to securely hold personal items while performing certain activities, like exercising.

While the preferred embodiment describes connecting elements together by, inter alia, welding, or fastening via threaded nuts, other fastening means can be used without limiting the scope of invention.

Although the present invention has been described with reference to its preferred embodiment, other embodiments, variations, and modifications can be made and still the result will come within the scope of the invention. No limitation with respect to the specific embodiments disclosed herein is intended or should be inferred.

Although the present invention has been described with reference to preferred embodiments, numerous modifications and variations can be made and still the result will come within the scope of the invention. The embodiments described are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. A security box comprising:
a box body with enclosing walls, defining an interior;
an access door giving access to the interior, with a portion of a frame of the security box body, adjacent to the access door, and having a lock which is further comprised by:
a rotating rod;
a cam latch resident on an internal end of the rotating rod; and
a hook structure resident on an end of the cam latch; and
a hook engagement bracket proximate the cam latch when said cam latch is in a locked position
wherein deformation causes the hook structure of the cam latch to engage the hook engagement bracket.

2. The security box of claim 1, further comprising a cam latch bracket resident proximate and surrounding the lock on at least two sides, the cam latch bracket featuring two opposed slots such that when the cam latch is in a locked position, opposed sides of the cam latch reside within the opposed slots.

3. The security box of claim 1, the hook engagement bracket of the security box comprising a post cantilevered from the frame of the security drop box and a head forming on the distal end of the post such that the combination of the post and head engages the hook during deformation.

4. The security box of claim 3, the frame having a passage slot to allow the cam latch to rotate into the locked position.

5. The security box of claim 1, the hook engagement bracket of the security drop box comprising a Z-shaped bracket with two parallel legs, one fixedly connected to the frame of the security drop box, and a stem therebetween.

6. The security drop box of claim 5, the hook engagement bracket also being affixed to the frame by an edge of the stem.

7. The security box of claim 6, the frame having a passage slot to allow the cam latch to rotate into the locked position.

8. The security box of claim 5, the frame having a passage slot to allow the cam latch to rotate into the locked position.

9. The security box of claim 1, the frame having a passage slot to allow the cam latch to rotate into the locked position and the frame about the passage slot serving as the hook engagement bracket.

10. The security box of claim 1, the access door being hinged along an edge opposite the lock and also further comprising a brace proximate said hinged edge on an inside of the access door.

11. The security box of claim 10, the first chamber being above the second chamber and the second chamber being gravity fed from the first chamber.

12. A lock for a security box, the lock comprising:
a rotating rod;
a cam latch resident an internal end of the rotating rod;
a hook structure resident on an end of the cam latch; and
a hook engagement bracket proximate the cam latch when said cam latch is in a locked position
wherein deformation causes the hook structure of the cam latch to engage the hook engagement bracket.

13. The lock of claim 12, further comprising a cam latch bracket resident proximate and surrounding the lock on at least two sides, the cam latch bracket featuring two opposed slots such that when the cam latch is in a locked position, opposed sides of the cam latch reside within the opposed slots.

14. The lock of claim 12, the hook engagement bracket of the security drop box further comprising a post cantilevered from a frame of the security box proximate the lock and a head forming the section of the hook engagement bracket parallel to the side of the security box.

15. The security box of claim 14, the frame having a passage slot to allow the cam latch to rotate into the locked position.

16. The lock of claim 12, the hook engagement bracket of the security drop box further comprising a Z-shaped bracket with two parallel legs, one fixedly connected to a frame of the security drop box, and a stem therebetween.

17. The lock of claim 15, the hook engagement bracket also being affixed to the frame by an edge of the stem.

18. The security box of claim 17, the frame having a passage slot to allow the cam latch to rotate into the locked position.

19. The security box of claim 16, the frame having a passage slot to allow the cam latch to rotate into the locked position.

20. The security box of claim 12, the having a passage slot to allow the cam latch to rotate into the locked position and the frame about the passage slot serving as the hook engagement bracket.
